(19) United States
(12) Patent Application Publication
(10) Pub. No.: US 2009/0121945 A1
(43) Pub. Date: May 14, 2009

(54) PORTABLE WIRE DEVICE

(75) Inventors: Kazuya Tani, Kanagawa (JP); Yoshio Koyanagi, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Kadoma-shi, Osaka (JP)

(21) Appl. No.: 11/994,435

(22) PCT Filed: Jul. 4, 2006
(86) PCT No.: PCT/JP2006/313268

§ 371 Date: Jan. 2, 2008

(30) Foreign Application Priority Data
Jul. 7, 2005 (JP) 2005-198713

(51) Int. Cl. H01Q 1/24; H01Q 3/24

(52) U.S. Cl. 343/702; 343/876

(57) ABSTRACT

A portable wireless device is capable of maintaining performance of an antenna without being affected by the state of the housing fitted with the antenna even if the housing is rotated around a rotation axis thereof by a predetermined angle. A portable wireless device 10 comprises an upper casing 21 provided with a balanced antenna 43 and a facing section 22a to be faced with the upper casing 21. The portable wireless device has two states including a first facing state in which the housing is in face to face relationship with the facing section and a second facing state in which the housing rotated around a rotation axis thereof by a predetermined angle is in face to face relationship with the facing section. The balanced antenna 43 has a shape symmetrical about a rotation axis 23b that is a rotation axis of the upper casing.

### TECHNICAL FIELD OF THE INVENTION

This invention relates to a portable wireless device such as a cellular phone and a personal digital assistance.

### BACKGROUND OF THE INVENTION

In recent years, there have been proposed, in response to the start of the digital terrestrial broadcasting and the expansion of the way in which portable wireless devices are used with high speed communication services, a wide variety of portable wireless devices of this type, one typical example of which has a main unit and a flip unit including an image display unit, the flip unit being connected with the main unit through a two-axis hinge and the like so that the flip unit is able not only to be open and closed but also to be reversed with respect to the main unit (refer to, for example, Patent Documents 1).

On the other hand, it is known that the portable wireless device comprises an antenna installed in a housing without having an effect on its design (refer to, for example, Patent Documents 2 or 3).

### Patent Document 1: Japanese Patent Laid-Open Publication No. 2004-214988

### Patent Document 2: Japanese Patent Laid-Open Publication No. 2004-165826

### Patent Document 3: Japanese Patent Laid-Open Publication No. 2003-37415

### DISCLOSURE OF THE INVENTION

### Problems to be Solved by the Invention

It is estimated that the above mentioned portable wireless device will become more and more popular in response to the start of the digital terrestrial broadcasting and the expansion of the way in which the portable wireless device is used with high speed communication services, and is expected to be often used under the condition that the flip unit (hereinafter referred to as “reversible unit”) has an inner surface provided with a main display unit such as a liquid crystal display, and assumes two different states including an inverted state in which the main display unit provided on the inner surface is visible from the outside, and a non-inverted state in which the main display unit provided on the inner surface is not visible from the outside. The portable wireless device is expected to perform with another device when in the inverted state and when in the non-inverted state.

The conventional portable wireless device, however, encounters such a problem that the performance of the antenna tends to be significantly affected and changed by the difference between the space to be occupied by the antenna when the reversible unit is in the inverted state and the space to be occupied by the antenna when the reversible unit is in the non-inverted state.

It is, therefore, an object of the present invention to provide a portable wireless device that can maintain the performance of an antenna without being affected by the state of the housing fitted with the antenna even if the housing is rotated around a rotation axis thereof by a specified angle.

### Means for Solving the Problems

The portable wireless device according to the present invention comprises a housing provided with a balanced antenna and a facing section to be faced with the housing, in which the portable wireless device has two states including a first facing state in which the housing is in face to face relationship with the facing section and a second facing state in which the housing rotated around a rotation axis thereof by a predetermined angle is in face to face relationship with the facing section, and the balanced antenna has a shape symmetrical about the rotation axis of the housing.

The portable wireless device thus constructed as previously mentioned can maintain the performance of the antenna without being affected by the state of the housing fitted with the antenna even if the housing is rotated around the rotation axis thereof by the predetermined angle.

The portable wireless device according to the present invention comprises a housing provided with a balanced antenna and a facing section to be faced with the housing, in which the portable wireless device has two states including a first facing state in which the housing is in face to face relationship with the facing section and a second facing state in which the housing rotated around a rotation axis thereof by a predetermined angle is in face to face relationship with the facing section, the balanced antenna has a shape symmetrical about a predetermined axis pointed in a direction perpendicular to the surface of the facing section, the predetermined axis being perpendicular to the rotation axis, under the condition that the housing is in face to face relationship with the facing section, or under the condition that the housing rotated around the rotation axis by the predetermined angle is in face to face relationship with the facing section.

The portable wireless device thus constructed as previously mentioned can maintain the performance of the antenna without being affected by the state of the housing fitted with the antenna even if the housing is rotated around the rotation axis thereof by the predetermined angle.

The portable wireless device according to the present invention may comprise a balanced feeder circuit for feeding the balanced antenna on the rotation axis.

The portable wireless device according to the present invention may comprise a balanced-unbalanced transformer and an unbalanced feeder circuit for feeding the balanced antenna through the balanced-unbalanced transformer.

In the portable wireless device according to the present invention, the balanced antenna has a plurality of antenna elements extending from the balanced feeder circuit, each of the plurality of antenna elements being equal in length to or greater in length than a half of a wavelength of a current flowing through each of the plurality of antenna elements.

As the portable wireless device thus constructed as previously mentioned can reduce the peak value of the current flowing through each antenna element, the portable wireless device can prevent unnecessary interference between the antenna elements and the casing and can stabilize the performance of the antenna without being affected by the state of the housing fitted with the antenna even if the housing is rotated around the rotation axis thereof by the predetermined angle.

The portable wireless device according to the invention may comprise an unbalanced feeder circuit, a ground unit and a matching circuit for connecting said unbalanced feeder circuit and said ground unit with said balanced antenna.

The portable wireless device according to the present invention comprises a housing provided with two unbalanced antennas, a facing section to be faced with the housing, detecting means for detecting the state of the housing with respect to the facing section, switching means for switching one of the two unbalanced antennas to the other one that is used for communications in accordance with a result of the detection performed by the detecting means, in which the portable wireless device has two states including a first facing state in which the housing is in face to face relationship with the facing section and a second facing state in which the housing rotated around a rotation axis thereof by a predetermined angle is in face to face relationship with the facing section, the two unbalanced antennas have a shape symmetrical about the rotation axis of the housing with respect to the facing section.

The portable wireless device thus constructed as previously mentioned can maintain the performance of the antenna without being affected by the state of the housing fitted with the antenna even if the housing is rotated around the rotation axis thereof by the angle.

### Effect of the Invention

The present invention provides a portable wireless device that can maintain the performance of an antenna without being affected by the state of the housing fitted with the antenna even if the housing is rotated around a rotation axis thereof by a specified angle.

### BRIEF DESCRIPTION OF DRAWINGS

The characteristics and advantages of the portable wireless device according to the present invention will be apparent from the following description, taken in conjunction with the accompanying drawings.

FIG. 1(a) is a perspective view of a portable wireless device according to a first embodiment of the present invention when an upper casing is in a first facing state.

FIG. 1(b) is a perspective view of the portable wireless device shown in FIG. 1(a) when an upper casing is in a second facing state.

FIG. 2(a) is a front elevational view of the portable wireless device shown in FIG. 1, showing an example of the shape of a balanced antenna.

FIG. 2(b) is a front elevational view of the portable wireless device shown in FIG. 1, showing an example of the shape of a balanced antenna different from the example shown in FIG. 2(a).

FIG. 2(c) is a front elevational view of the portable wireless device shown in FIG. 1, showing an example of the shape of a balanced antenna different from the examples shown in FIG. 2(a) and FIG. 2(b).

FIG. 3 is a front elevational view of the portable wireless device shown in FIG. 1, showing an example of the shape of a balanced antenna different from the examples shown in FIGS. 2(a) to 2(c).

FIG. 4 is a front elevational view of the portable wireless device shown in FIG. 1, showing an example of a current distribution.

FIG. 5 is a front elevational view of the portable wireless device shown in FIG. 1, showing a radiation pattern of radio waves in the state shown in FIG. 4.

FIG. 6 is a front elevational view of the portable wireless device shown in FIG. 1, showing an example of a radiation pattern of radio waves different from the example shown in FIG. 4.

FIG. 7 is a front elevational view of the portable wireless device shown in FIG. 1, showing an example of the shape of a balanced antenna different from the examples shown in FIG. 2(a) to 2(c) and FIG. 3.

FIG. 8 is a front elevational view of the portable wireless device shown in FIG. 1, showing an example of the shape of a balanced antenna different from the examples shown in FIG. 2(a) to 2(c), FIG. 3 and FIG. 7.

FIG. 9(a) is a partial plan view of the portable wireless device shown in FIG. 1 focusing on the balanced antenna, showing an example of a method for feeding the balanced antenna.

FIG. 9(b) is a partial plan view of the portable wireless device shown in FIG. 1 focusing on the balanced antenna, showing an example of a method for feeding the balanced antenna.

FIG. 10(a) is a perspective view of a portable wireless device according to a second embodiment of the present invention when an upper casing is in a first facing state.

FIG. 10(b) is a perspective view of the portable wireless device shown in FIG. 10(a) when the upper casing is in a second facing state.

FIG. 11(a) is a perspective view of a portable wireless device according to a third embodiment of the present invention when an upper casing is in a first facing state.

FIG. 11(b) is a perspective view of the portable wireless device shown in FIG. 11(a) when the upper casing is in a second facing state.

### DESCRIPTION OF THE REFERENCE NUMERALS

10: portable wireless device
21: upper casing (housing)
22a: facing section
23b: rotation axis (reverse axis)
41: balanced transmit-receive radio frequency circuit (balanced feeder circuit)
42: matching circuit
43: balanced antenna
45: balanced-unbalanced transformer
46: unbalanced transmit-receive radio frequency circuit (unbalanced feeder circuit)
47: ground unit
70: portable wireless device
71: axis (predetermined axis)
80: portable wireless device
81, 82: unbalanced antenna
83: switching circuit (switching means)
84: sensor unit (detecting means)

### DETAILED DESCRIPTION OF THE INVENTION

### First Embodiment

The configuration of a portable wireless device according to the first embodiment will be described.

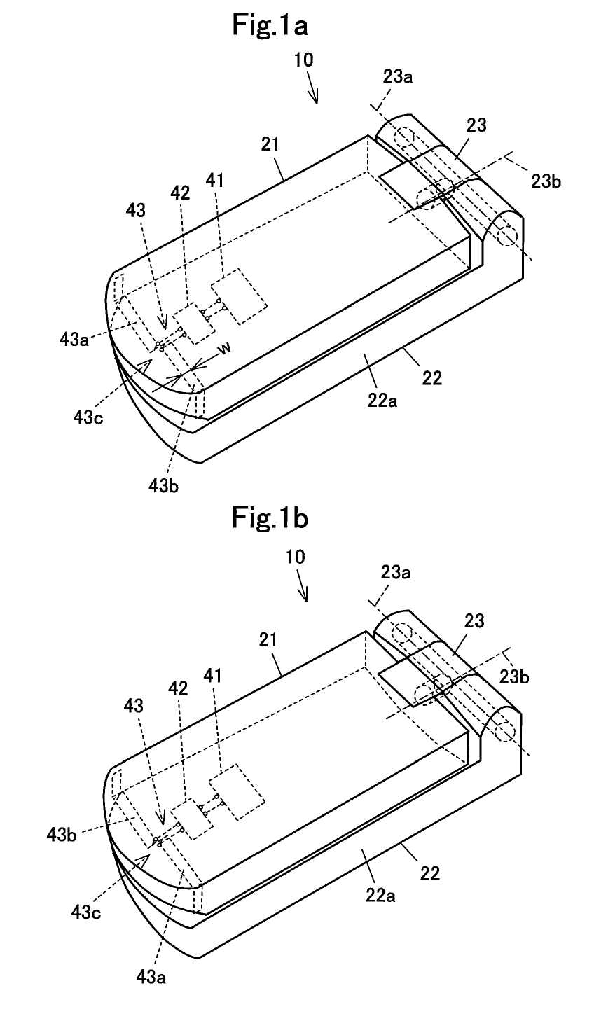

As shown in FIGS. 1(a) and 1(b), a portable wireless device 10 according to the first embodiment comprises an upper casing 21, a lower casing 22 having a facing section 22a to be faced with the upper casing 21, and a two-axis hinge 23 that is supported by the lower casing 22 and pivotably movable about a rotation axis 23a and that supports the upper casing 21 and rotatably movable about a rotation axis 23b perpendicular to the rotation axis 23a. In FIG. 1(a), the portable wireless device 10 is in a first facing state where the upper casing 21 is in face to face relationship with the facing section 22a. The upper casing 21 is designed to pivots about the rotation axis 23a by use of the two-axis hinge 23 in a direction of the side opposite to the lower casing 22, then rotates 180 degrees about the rotation axis 23b by use of the two-axis hinge 23, and then pivots about the rotation axis 23a by use of the two-axis hinge 23 in a direction of the side of the lower casing 22, resulting in the fact that the portable wireless device 10 is in a second facing state where the upper casing 21 rotated about the rotation axis 23b by 180 degrees is in face to face relationship with the facing section 22a as shown in FIG. 1(b).

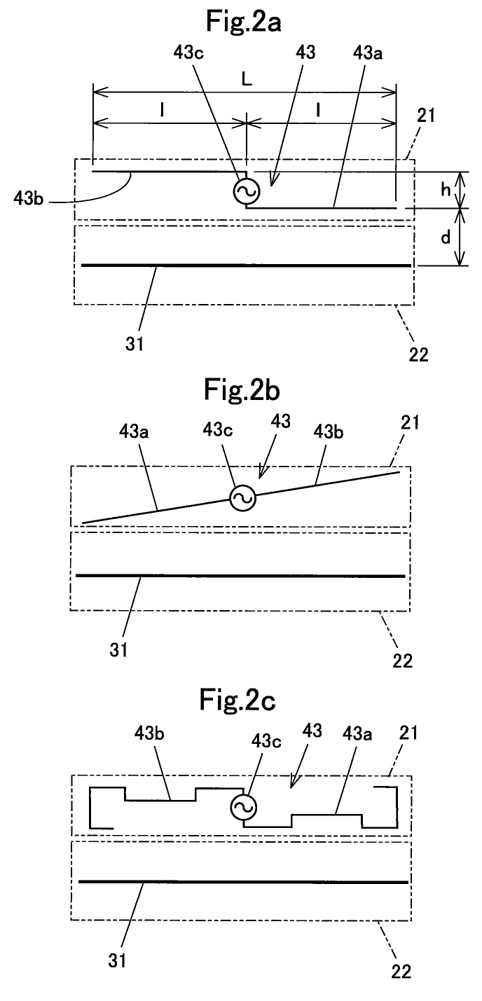

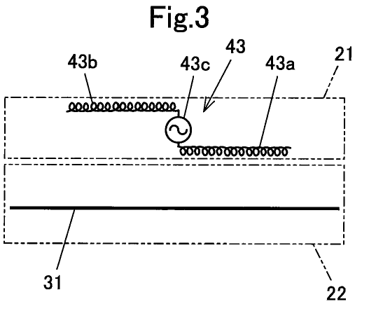

The portable wireless device 10 has a ground substrate 31 (see FIG. 2) provided in the lower casing 22. The portable wireless device 10 further has a balanced transmit-receive radio frequency circuit 41, a matching circuit 42 connected to the balanced transmit-receive radio frequency circuit 41 and a balanced antenna 43 connected to the matching circuit 42 provided in the upper casing 21. This means that the upper casing 21 constitutes a housing.

The balanced antenna 43 has antenna elements 43a and 43b and a feeder unit 43c disposed on the rotation axis 23b that is an axis (reverse axis) of the reversal of the upper casing 21 with respect to the facing section 22a. The balance antenna 43 is disposed in the upper casing 21 and has a shape with 180-degree rotational symmetry about the rotation axis 23b. Examples of the shapes of the balanced antenna 43 are shown in FIGS. 2(a) to 2(c). Furthermore, the balanced antenna 43 may take the form of a helical structure, meander structure and the like to be operable over a low frequency band and to expand a frequency band in which the balanced antenna 43 is operable. The antenna elements 43a and 43b are formed by, for example, a conducting line, a band-shaped conducting line, a dielectric material capable of reducing the electrical length of the balanced antenna 43, or the like. The balanced transmit-receive radio frequency circuit 41 is preferably formed on the reverse axis since the distance between the balanced transmit-receive radio frequency circuit 41 and the antenna affects the length of the antenna.

Next the operation of the portable wireless device 10 will be described.

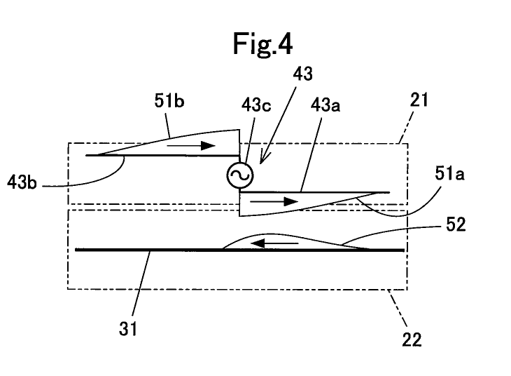

The current distribution of the portable wireless device 10 simulated by using a finite difference time domain (FDTD) method is shown in FIG. 4. In this case, the balanced antenna 43 has a shape shown in FIG. 2(a), the balanced antenna 43 operates at substantially a half of a wavelength λ of a target frequency 2.0 GH, each of the antenna elements 43a and 43b has a width (w) (see FIG. 1(a)) of 3.0 mm and a length (l) of 33 mm, the total length (L) of the antenna elements 43a and 43b is 66 mm, the distance (d) between either one of the antenna elements 43a and 43b that is closer to the ground substrate 31 and the ground substrate 31 is 4 mm, and a distance (h) of movement of each of the antenna elements 43a and 43b due to the reversal of each of the antenna elements 43a and 43b is 10 mm.

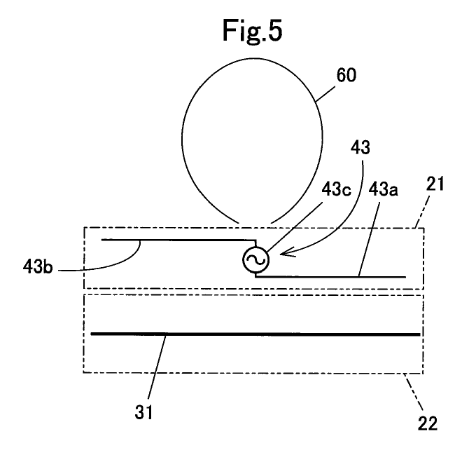

In FIG. 4, currents 51a and 51b having the same phase as each other flow through the antenna elements 43a and 43b, respectively, while a current 52 that is in antiphase with the current 51a flows through the ground substrate 31. Thus, in the first facing state where the antenna element 43a is close to the ground substrate 31, the antenna element 43b separated from the ground substrate 31 greatly contributes as a radiating element for radiating radio waves while the antenna element 43a does not greatly contribute as a radiating element for radiating radio waves due to the effect of the ground substrate 31. The radiation pattern of radio waves from the balanced antenna 43 in the first facing state shown in FIG. 4 is like a pattern 60 shown in FIG. 5.

In the second state (not shown) where the upper casing 21 rotated about the rotation axis 23b by 180 degrees is in face to face relationship with the facing section 22a and the antenna element 43b is close to the ground substrate 31, the antenna element 43a separated from the ground substrate 31 greatly contributes as a radiating element for radiating radio waves while the antenna element 43b does not greatly contribute as a radiating element for radiating radio waves due to the effect of the ground substrate 31. Since the balanced antenna 43 has a shape with 180-degree rotational symmetry about the rotation axis 23b, the radiation capacity of the whole balanced antenna 43 is the same before and after the reversal of the balanced antenna 43.

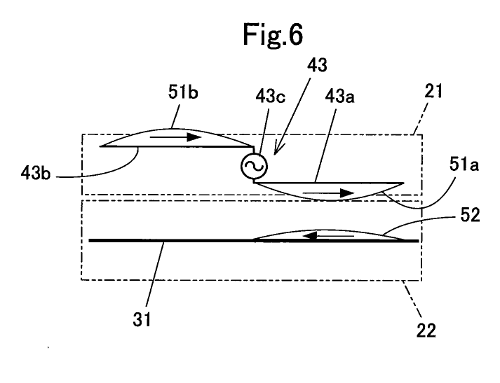

The current distribution of the portable wireless device 10 simulated by using the FDTD method is like the one shown in FIG. 6. In this case, the balanced antenna 43 having a shape shown in FIG. 2(a) is used, and operates at substantially the wavelength λ; each of the antenna elements 43a and 43b has the width (w) of 3.0 mm and the length (l) of 33 mm; the total length (L) of the antenna elements 43a and 43b is 66 mm the distance (d) is 4 mm; and the distance (h) is 10 mm. As the current distribution on the antenna elements 43a and 43b is concentrated near the feeder unit 43c, the peak values of the currents on the antenna elements 43a and 43b are large in the case that the balanced antenna 43 operates at substantially a half of the wavelength λ as shown in FIG. 4. In contrast as the currents on the antenna elements 43a and 43b reach the peak values near the center of each of the antenna elements 43a and 43b respectively in the case that the balanced antenna 43 operates at substantially the wavelength λ as shown in FIG. 6, the peak values of the currents on the antenna elements 43a and 43b is small compared with the case in which the balanced antenna 43 operates at substantially a half of wavelength λ. Likewise, in the case that the balanced antenna 43 operates at substantially ¾ of wavelength λ, the peak values of the currents on the antenna elements 43a and 43b is small compared with the case in which the balanced antenna 43 is operated at substantially a half of wavelength λ.

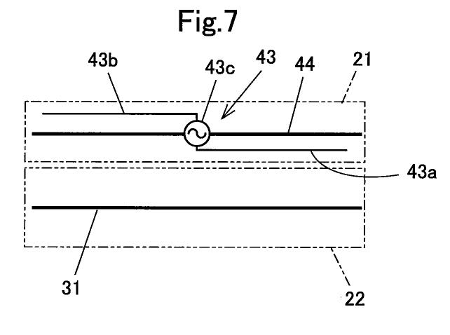

In the case that the portable wireless device 10 includes a ground substrate 44 disposed between the antenna elements 43a and 43b in the upper casing 21 as shown in FIG. 7, either one of the antenna elements 43a and 43b that is disposed between the ground substrate 31 and the ground substrate 44 does not contribute as a radiating element for radiating radio waves compared with that in the state shown in FIG. 4 due to the effect of both the ground substrate 31 and the ground substrate 44. However, the radiation capacity of the whole balanced antenna 43 is the same before and after the reversal, since the balanced antenna 43 has a shape with 180-degree rotational symmetry about the rotation axis 23b.

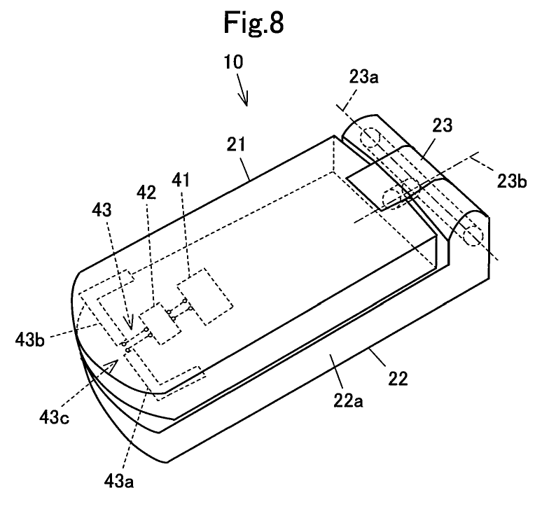

In the case that the distance between the antenna element 43a and the ground substrate 31 (see FIG. 2) and the distance between the antenna element 43b and the ground substrate 31 are the same, the abilities of both the antenna elements 43a and 43b as radiating elements for radiating radio waves equally slightly deteriorates. However, the radiation capacity of the whole balanced antenna 43 is the same before and after the reversal since the balanced antenna 43 has a shape with 180-degree rotational symmetry about the rotation axis 23b. In the portable wireless device 10, the balanced antenna 43 shown in FIG. 8 may be formed by an antenna pattern shaped on the ground substrate 44 included in the upper casing 21 as shown in FIG. 7.

As described above, the portable wireless device 10 can maintain the performance of the balanced antenna 43 regardless of whether the upper casing 21 is in the first facing state or in the second facing state. Thus the portable wireless device 10 can exhibit stable sensitivity when performing communications regardless of whether the upper casing 21 is in the first facing state or in the second facing state.

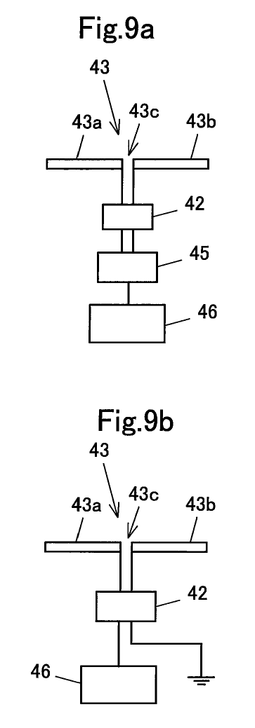

The portable wireless device 10 comprises the balanced t-receive radio frequency circuit 41 that is a balanced feeder circuit for feeding the balanced antenna The portable wireless device 10, however, may have an unbalanced feeder circuit to feed the balanced antenna 43b. The portable wireless device 10 may include, for example, a balanced-unbalanced transformer 45 and an unbalanced transmit-receive radio frequency circuit 46 as an unbalanced feeder circuit in place of the balanced transmit-receive radio frequency circuit 41 as shown in FIG. 9(a) to feed the balanced antenna 43 from the unbalanced transmit-receive radio frequency circuit 46 through the balanced-unbalanced transformer 45. Furthermore, the portable wireless device 10, as shown in FIG. 9(b), may comprise the unbalanced transmit-receive radio frequency circuit 46 and a ground unit 47 in place of the balanced transmit-receive radio frequency circuit 41 to feed the balanced antenna 43 from the unbalanced transmit-receive radio frequency circuit 46 through the matching circuit 42. In this case, the portable wireless device 10 can obtain a characteristic similar to that of the balanced antenna since the current flows also to the antenna element 43b by optimally adjusting the matching circuit 42.

The present invention is not limited to the above-described embodiment in which the casing provided with the antenna can be reversed 180 degrees with respect to the other casing and the antenna has the shape with 180-degree rotational symmetry about the reverse axis. Even in the case that the casing provided with the antenna can be rotated through a predetermined angle other than 180 degrees with respect to the other casing, the predetermined angle can be any angle as long as the antenna has a shape with the predetermined angle of rotational symmetry about the rotation axis of the casing provided with the antenna.

The present invention is not limited to the above-described embodiment in which the antenna comprises two antenna elements. The antenna may comprise any number of antenna elements as long as the antenna provided in the casing has a shape with rotational symmetry about the reverse axis of the casing provided with the antenna regardless of whether the portable wireless device is in the state where the casing is in face to face relationship with the facing section or in the state where the casing rotated about the rotation axis thereof by 180 degrees is in face to face relationship with the facing section.

### Second Embodiment

The configuration of a portable wireless device according to the second embodiment will be described.

Some of components of the portable wireless device according to the second embodiment which are similar to those of the portable wireless device 10 according to the first embodiment (see FIG. 1), are assigned the same reference numerals to thereby omit description thereof.

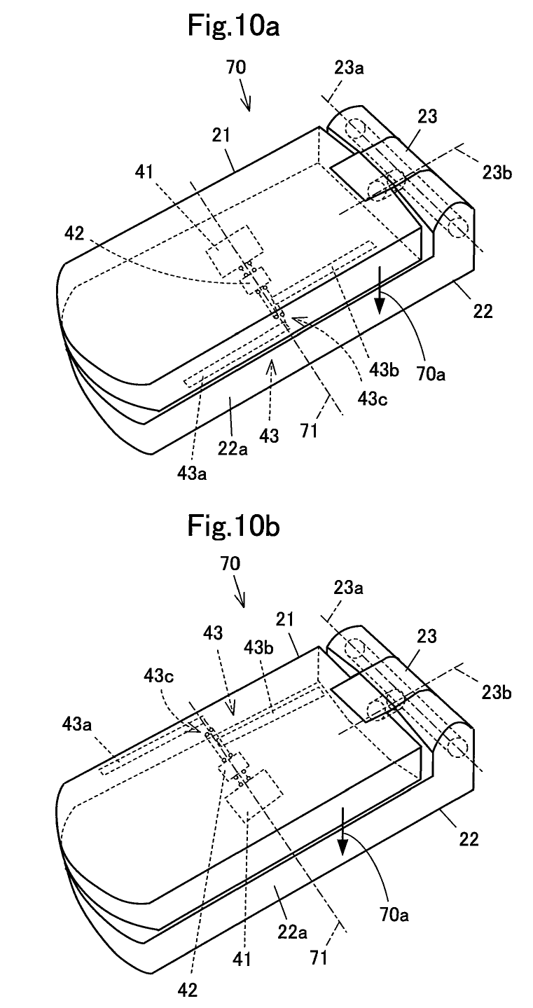

The position of the balanced antenna 43 disposed in the upper casing 21 of the portable wireless device 70 according to the second embodiment is different from that of the balanced antenna 43 of the portable wireless device 10 as shown in FIG. 10.

The balanced antenna 43 of the portable wireless device 70 has the feeder unit 43c disposed on a predetermined axis 71 and has a shape with 180-degree rotational symmetry about the axis 71.

The axis 71 extends in a direction perpendicular to a direction shown by an arrow 70a pointing toward the facing section 22a from the upper casing 21 and to an extension of the rotation axis 23b that is the reverse axis of the upper casing 21 when the portable wireless device 70 is in a first facing state where the upper casing 21 is in face to face relationship with the facing section 22a as shown in FIG. 10(a) and in a second facing state where the upper casing 21 rotated about the rotation axis 23b by 180 degrees is in face to face relationship with the facing section 22a is as shown in FIG. 10(b).

The portable wireless device 70 can maintain the performance of the balanced antenna 43 regardless of whether portable wireless device 70 is in the first facing state or in the second facing state in the same way as the portable wireless device 10 according to the first embodiment, although the radiation pattern of the balanced antenna 43 is reversed with respect to the rotation axis 23b before and after the reversal of the upper casing 21. Thus, the portable wireless device 70 can exhibit stable sensitivity when performing communications regardless of whether the upper casing 21 is in the first state or in the second state.

In the portable wireless device 70, the balanced antenna 43 may have any of the same shapes as in the first embodiment, and the method for feeding the balanced antenna 43 may be used in the same ways as in the first embodiment.

The present invention is not limited to the above-described embodiment in which the casing provided with the antenna can be reversed 180 degrees with respect to the other casing and the antenna has a shape with 180-degree rotational symmetry about the reverse axis of the casing provided with the antenna Even in the case that the casing provided with the antenna can be rotated through a predetermined angle other than 180 degrees with respect to the other casing, the predetermined angle can be any angle as long as the antenna has a shape with rotational symmetry about the rotation axis of the casing provided with the antenna.

The present invention is not limited to the above-described embodiment in which the antenna comprises two antenna elements. The antenna may comprise any number of antenna elements as long as the antenna provided in the casing has a shape with rotational symmetry about the reverse axis of the casing provided with the antenna.

### Third Embodiment

The configuration of a portable wireless device according to the third embodiment will be described.

The components of the portable wireless device according to the present embodiment, which are similar to those of the portable wireless device 10 according to the first embodiment (see FIG. 1) are assigned the same reference numerals to thereby omit description thereof.

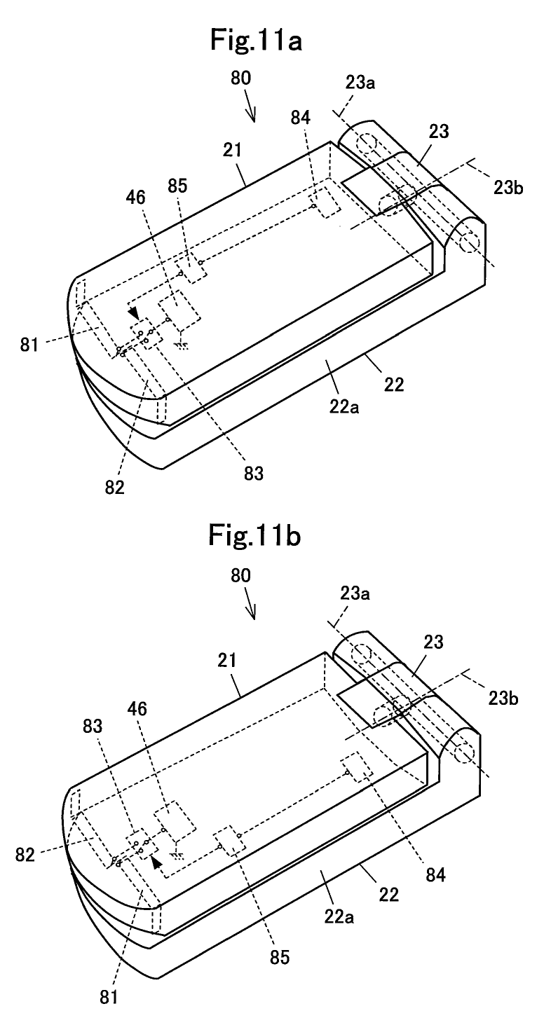

The portable wireless device 80 according to the present embodiment comprises an unbalanced transmit-receive radio frequency circuit 46, unbalanced antennas 81 and 82, a switching circuit 83 as switching means for switching to one of the unbalanced antennas 81 and 82 to be connected with the unbalanced transmit-receive radio frequency circuit 46 and used for communications, a sensor unit 84 as a detecting means for detecting the state of the upper casing 21 with respect to the facing section 22a, and a control unit 85 for causing the switching circuit 83 to switch the state of the connection in accordance with a detection result obtained by the sensor unit 84 in the upper casing 21 as shown in FIG. 11.

The unbalanced antennas 81 and 82 have a shape with 180-degree rotational symmetry about the rotation axis 23b that is the reverse axis of the upper casing 21 with respect to the facing section 22a. Since the unbalanced antennas 81 and 82 separately operate, they may be separated from each other. The unbalanced antennas 81 and 82 can also be arranged in various shapes in the same way as the antenna elements 43a and 43b of the portable wireless device 10 according to the first embodiment.

The switching circuit 83 is constructed of PIN (P-Intrinsic-N) diodes, band switching diodes or the like.

The sensor unit 84 is constructed of, for example, a permanent magnet (not shown) provided in the lower casing 22, a magnetometer (not shown) that is a coil and the like provided in the upper casing 21 and is in face to face relationship with the permanent magnet in the lower casing 22.

Next, the operation of the portable wireless device 80 will be described.

The control unit 85 causes either one of the unbalanced antennas 81 and 82 that is farther from the lower casing 22 and the unbalanced transmit-receive radio frequency circuit 46 to be connected with the switching circuit 83 in accordance to the detection result from the sensor unit 84. Thus, in the portable wireless device 80, the unbalanced antenna 82 that is farther from the lower casing 22 is used for communications in the first facing state shown in FIG. 11(a) while the unbalanced antenna 81 that is farther from the lower casing 22 is used for communications in the second facing state shown in FIG. 11(b).

As described above, the portable wireless device 80 can maintain the performance of the antenna used for communications with another device, without being affected by the state of the housing fitted with the antenna even if the housing is rotated around the rotation axis thereof by 180 degrees. Thus, the portable wireless device 80 can exhibit stable sensitivity when performing communications regardless of whether the upper casing 21 is in the first state or in the second state.

Also, the portable wireless device 80 has a high antenna efficiency since either one of the unbalanced antennas 81 and 82 which is farther from the lower casing 22, or which is not significantly affected by the ground substrate and the like provided in the lower casing 22, is used for communications.

In the portable wireless device 80, the detecting means has the sensor unit 84. The detecting means, however, may have a component other than the sensor unit 84. The detecting means, for example, may detect the state of the upper casing 21 with respect to the facing section 22a based on the type of an application in use.

The present invention is not limited to the above-described embodiment in which the casing provided with the antenna can be reversed 180 degrees with respect to the other casing and the antenna has a shape with 180-degree rotational symmetry about the reverse axis. Even in the case that the casing provided with the antenna can be rotated through a predetermined angle other than 180 degrees with respect to the other casing, the predetermined angle may be any angle as long as the antenna has a shape with rotational symmetry about the rotation axis of the casing provided with the antenna.

The present invention is not limited to the above-described embodiment in which the antenna comprises two antenna elements. The antenna may comprise three or more antenna elements as long as the antenna provided in the casing has a shape with rotational symmetry about the reverse axis of the casing provided with the antenna without being affected by the state of the casing even if the casing is rotated around the rotation axis thereof by a predetermined angle.

### INDUSTRIAL APPLICABILITY OF THE PRESENT INVENTION

As disclosed above, the portable wireless device according to the present invention is capable of maintaining the performance of the antenna without being affected by the state of the casing even if the casing is rotated around the rotation axis thereof by a predetermined angle, and is useful as a cellular phone, personal digital assistance and the like.

What is claimed is:

1. A portable wireless device, comprising:
a housing provided with a balanced antenna; and
a facing section to be faced with said housing,
said portable wireless device having two states including a first facing state in which said housing is in face to face relationship with said facing section and a second facing state in which said housing rotated around a rotation axis thereof by a predetermined angle is in face to face relationship with the facing section, and
said balanced antenna has a shape with said predetermined angle of rotational symmetry about said rotation axis of said housing with respect to said facing section.

2. A portable wireless device, comprising:
a housing provided with a balanced antenna; and
a facing section to be faced with said housing,
said portable wireless device having two states including a first facing state in which said housing is in face to face relationship with said facing section and a second facing state in which said housing rotated around a rotation axis thereof by a predetermined angle is in face to face relationship with the facing section,
said balanced antenna has a shape symmetrical about a predetermined axis pointed in a direction perpendicular to the surface of said facing section, said predetermined axis being perpendicular to said rotation axis, under the condition that said housing is in face to face relationship with said facing section, or under the condition that said housing rotated around a rotation axis thereof by a predetermined angle is in face to face relationship with said facing section.

3. A portable wireless device as set forth in claim 1, further comprising a balanced feeder circuit that feeds said balanced antenna and is disposed on said rotation axis.

4. A portable wireless device as set forth in claim 2, further comprising a balanced feeder circuit that feeds said balanced antenna and is disposed on said rotation axis.

5. A portable wireless device as set forth in claim 3, wherein
said balanced antenna has a plurality of antenna elements extending from said balanced feeder circuit, and
each of said plurality of antenna elements is equal in length to or greater in length than a half of a wavelength of a current flowing through each of said plurality of antenna elements.

6. A portable wireless device as set forth in claim 4, wherein
said balanced antenna has a plurality of antenna elements extending from said balanced feeder circuit,
each of said plurality of antenna elements is equal in length to or greater in length than a half of a wavelength of a current flowing through each of said plurality of antenna elements.

7. A portable wireless device as set forth in claim 1, further comprising a balanced-unbalanced transformer and an unbalanced feeder circuit for feeding said balanced antenna through said balanced-unbalanced transformer.

8. A portable wireless device as set forth in claim 2, further comprising a balanced-unbalanced transformer and an unbalanced feeder circuit for feeding said balanced antenna through said balanced-unbalanced transformer.

9. A portable wireless device as set forth in claim 1, further comprising an unbalanced feeder circuit, a ground unit and a matching circuit for connecting said unbalanced feeder circuit and said ground unit with said balanced antenna.

10. A portable wireless device as set forth in claim 2, further comprising an unbalanced feeder circuit, a ground unit and a matching circuit for connecting said unbalanced feeder circuit and said ground unit with said balanced antenna.

11. A portable wireless device, comprising:
a housing provided with two unbalanced antennas; and
a facing section to be faced with said housing;
detecting means for detecting the state of said housing held by said facing section; and
switching means for switching one of said two unbalanced antennas to the other unbalanced antenna that is used for communications in accordance with a result of the detection performed by said detecting means,
said portable wireless device having two states including a first facing state in which said housing is in face to face relationship with said facing section and a second facing state in which said housing rotated around a rotation axis thereof by a predetermined angle is in face to face relationship with the facing section, and
said two unbalanced antennas having a shape symmetrical about a rotation axis of said housing.
